(19) United States
(12) Patent Application Publication
(10) Pub. No.: US 2025/0002377 A1
(43) Pub. Date: Jan. 2, 2025

(54) WASTEWATER TREATMENT SYSTEM AND METHOD USING REUSABLE TECHNOLOGIES

(71) Applicant: EXPOSOME PVT. LTD., Mumbai (IN)

(72) Inventor: Prerna Goradia, Mumbai (IN)

(21) Appl. No.: 18/830,548

(22) Filed: Sep. 10, 2024

Related U.S. Application Data
(63) Continuation of application No. PCT/IN2023/050226, filed on Mar. 10, 2023.

(30) Foreign Application Priority Data
Mar. 10, 2022 (IN) 202221012966

(51) Int. Cl. C02F 1/461; B01D 69/02; B01D 69/10; B01D 69/12; B01D 71/56; C02F 1/467

(52) U.S. Cl. CPC C02F 1/46109; B01D 69/02; B01D 69/107; B01D 69/12; B01D 71/56; C02F 1/4672; C02F 1/4676; B01D 2325/04; C02F 2001/46133; C02F 2001/46161; C02F 2201/46115; C02F 2201/46185; C02F 2201/4619; C02F 2301/022; C02F 2301/046; C02F 2305/023

(57) ABSTRACT

The present invention relates to system and method for lowering the pollutants in waste water and electro transformation of waste waters and other reactants. A unique flow-through system is introduced where separate streams of oxidants and reductants can be introduced in the electrolysis chamber (100) and do not mix too much due to the laminar flow. The by-products can be easily separated from the outlets from both the anodic (101) and the cathodic chambers (102) by a cost-effective separator and the gases can be introduced back into the electrosynthesis chambers as required to break-down the pollutants.

### RELATED APPLICATIONS

This application claims priority under 35 U.S.C. § 120 to, and is a continuation of, co-pending International Application PCT/IN2023/050226, filed Mar. 10, 2023 and designating the US, which claims priority to IN application 202221012966, filed Mar. 10, 2022, such IN Application also being claimed priority to under 35 U.S.C. § 119. These IN and International applications are incorporated by reference herein in their entireties.

### FIELD

The present invention broadly relates to a system and method for wastewater treatment and electro transformation of reactants into liquid and gas-based value-added products. More particularly, the invention relates to a system and method for lowering the pollutants such as recalcitrant chemical oxygen demand, inorganic and organic pollutants in the wastewater, sewage, medical waste, scrubber water and industrial waste.

### BACKGROUND

In modern cities, the actual population has developed different ways to reach a certain level of comfort for the daily life. To satisfy the comfort of modern-day lifestyle, food (crops, cattle, processed food) and industrial (hydrocarbons, pharmaceuticals, electronics) production has increased, as well as the development of new synthetic products (xenobiotics). Unfortunately, the activities related to satisfying this level of convenience, are accompanied by agricultural, industrial and urban wastes, many of them eventually delivered (treated or untreated) to the environment (air, soil and water). Organic wastes, in general, can be used or reused for other process, like compost or methane production. However, some inorganic and synthetic compounds are considered recalcitrant or non-biodegradable. Recalcitrant pollutants, including hydrocarbons, pesticides, some personal care products, nanomaterials, and different types of toxins, are on the raise and are attracting increasing attention due to their negative effects, persistence, and bio magnification in natural and human environments. Effective remediation of these pollutants in the environment is, therefore, of great importance for the re-establishment of ecological health. Because of the recalcitrance of the pollutants, conventional remediation techniques (e.g., bioremediation and classical physical and chemical processes) are not as effective, as fast, or generate undesirable by products.

Since ancient times, alum in combination with aeration has been the most tested method for the treatment of organic pollutants. In the past few years, activated carbon and microbes have been the known method for the treatment of sewage and wastewater and in turn reduction of recalcitrant chemical oxygen demand, herein referred to as COD.

But there are shortcomings such as less efficient and poor recyclability, toxicity, and narrow range of application.

References have been made to the following literature:

Article by SiamakAzimiMaleki relates to photo catalytic degradation of ethylene dichloride (EDC) wastewater in a batch photocatalytic reactor using titanium dioxide (TiO2)/graphene hybrid as the catalyst. The main advantage of this structure, in which graphene is used as a bed for TiO2, is that it enhanced the electron transfer considerably.

KR20200089088 relates to a wastewater treatment method including: a first step of decomposing a nickel-cyanide complex into nickel and cyanide ions by performing a pulse electrolysis process on wastewater containing the nickel-cyanide complex; a second step of filtering and recovering the nickel deposited in the wastewater; and a third step of decomposing cyanide ions contained in the wastewater in which nickel is recovered into carbon dioxide and nitrogen through an oxidation reaction.

U.S. Pat. No. 10,486,992B2 relates to the use of activated carbon in a membrane bioreactor. A membrane bioreactor (MBR) has membranes comprising a supporting structure. A supply unit doses a sorbent such as powdered activated carbon (PAC) into the MBR. The PAC is maintained at a concentration in the mixed liquor of 200 mg/L or more. Mixed liquor with the sorbent particles recirculates within the MBR at a flow rate of at least twice the feed flow rate. Air bubbles are provided to scour the membranes including during at least part of a permeation step. The sorbent particles are present in the mixed liquor and contact the membranes. Bioaugmentation products may be immobilized on PAC or other carriers and then added to an MBR or other bioreactors.

AU2020104239A4 relates to a graphene-based purification method and device for medical sewage in general hospitals.

CN104176797B relates to a system to a kind of organic wastewater with difficult degradation thereby apparatus for electrochemical treatment and method, devise the SPE electroxidation sewage processing electrolytic cell of a kind of “zero pole span” being similar to solid polymer electrolyte fuel cell technology. This device utilizes ion exchange membrane to separate anode chamber and cathode chamber, and utilizes end plate (titania dimensionally stable) anode, ion exchange membrane and (nickel) negative electrode to be compressed, and forms the SPE electroxidation sewage processing electrolytic cell of “zero pole span”. This device is when electrolysis runs, and wastewater, in anode generation electroxidation, makes Organic substance in water and ammonia nitrogen obtain mineralizing and degrading; Cathode chamber passes into tap water (or wastewater), and catholyte liberation of hydrogen is recycled.

It is evident that despite the widespread use of activated carbon and microbes for the treatment of industrial waste and sewage water, they have a limited durability and there are chances of leaching of the toxic chemicals. To counteract these claims a reusable and robust platform and materials to lower the COD in wastewaters is the need of the hour.

The information disclosed in this background of the disclosure section is only for enhancement of understanding of the general background of the invention and should not be taken as an acknowledgement or any form of suggestion that this information forms the prior art already known to a person skilled in the art.

### SUMMARY

The present invention attempts to overcome the problems faced in the prior art, and discloses a system and method which can effectively lower the recalcitrant COD by providing for a stabilized, non-toxic, antimicrobial system that generates useful by-products. The bacterial loading is also controlled as the oxidation and reduction reactions taking place at the electrodes generate radical species that are biocidal. The clear filtrate is often times separated along with the solid sludge. This method can also be used for the electrosynthesis of industrial products.

In an exemplary embodiment the invention discloses an electrolytic system for lowering the pollutants in wastewater treatment and electro synthesis of reactants, comprising an electrolysis chamber with anodic and cathodic chamber, with inlet and outlet duct; the chambers with one anode electrode and one cathode electrode, where the composition of electrode comprises of non-sacrificial carbon, resin and catalyst and the entire electrode surface is exposed for maximum current to pass and in turn more flow of reactants; at least one membrane separating the anode and cathode chamber, to avoid intermixing of reactants in the two chambers; at least one outlet for collecting the valuable by-products, further the outlets and the chambers in the system is customizable as per the desired by products and the flow/turbulence is introduced in the system to increase the rate of reaction and energy source for providing the voltage.

In an embodiment, the anode electrode is a carbon-based electrode comprising graphene, graphite, resin and catalyst made by hot or cold pressing and the cathode electrode comprises graphene, natural graphite flakes purified by dilute sulfuric acid process, resin, catalyst, stainless steel or sandwiched stainless steel. Further, the electrode comprises of 95 to 100% graphite, <1% graphene, 0 to 1% catalyst, resin optional 0 to 30%, insulator optional 0 to 10%, where optionally contains steel frame. Graphite due to its electrical conductivity may be used as electrodes. Owing to its anisotropic nature, graphite can carry out chemical reactions by allowing the reactant molecules to intercalate between graphene layers. These types of reactions are called intercalation.

In a preferred embodiment, the electrode is Teflon impregnated to increase the mechanical strength and the anode and cathode electrode is used interchangeably depending upon the type of waste treatment or the electrosynthesis reaction. In an embodiment, at least one of the electrodes is a porous electrode and the flux of reactants is more due to the enhanced surface area of the electrodes.

In another embodiment, the catalyst is selected from a group comprising platinum group metals (PGM metals) as well as transition metals such as copper, ruthenium, palladium, platinum, silver, zinc, molybdenum, graphene, CNTs. Further, the particulate resin is selected from the group consisting of synthetic resins, pumice, and artificial pellets, Phenolic Resin, Phenol Formaldehyde Resin, Ultra-high-molecular-weight polyethylene.

In an embodiment, the membrane for separating the anode and the cathode chamber is selected from an ion exchange membrane, reverse osmosis membrane and combinations thereof, with variable pore size depending upon the desired wastewater treatment and the by product to be separated.

In a preferred embodiment the present invention discloses a method for treating wastewater and electrosynthesis of reactants, comprising the steps of: (a) adding the wastewater or reactant solution to an electrolyzer or reactor chamber wherein said electrolyzer comprises a dimensionally stable graphene anode and a cathode in at least one anode and at least one cathode chamber; (b) electrolyzing and oxidizing/reducing the wastewater for lowering the pollutants with continuously introducing strong electrolytes to the electrolysis chamber for lowering the current/fastening the reaction, wherein simultaneous oxidation and reduction take place in two chambers as per the requirement; (c) introducing flow in the chambers by spargers or gas turbulence; and (d) collecting the by-products produced during the treatment process, wherein the one of the by product is at least a gas for further action. Further, the strong electrolyte for fastening the reaction in the electrolysis chamber is selected from a group comprising sodium sulphate, sodium chloride, potassium chloride, potassium hydroxide and combinations thereof and the energy source is plug in or solar energy for maintaining the voltage in the system. This would truly be the case of energy generation and waste treatment using renewable sources.

In an embodiment, the process is fastened by continuously recirculating the wastewater through a recycling conduit connected with said reactor by means of a recirculation pump and the by product is bubbled back to the chamber for faster electro chemical process. Further, simultaneous controlled oxidation and reduction reaction can take place in the two chambers.

In an embodiment, the electrolysis process for wastewater treatment is an electro oxidation and reduction process and uses non sacrificial carbon electrodes selected on the basis of the capacity to generate hydroxyl radicals and other secondary oxidants.

In an exemplary embodiment the present invention discloses a method for the treatment of the wastewater and reducing recalcitrant COD including the steps of immersing the system in the wastewater. In the system hydrogen gas is generated on the cathode which is collected by a gas absorption unit. The two specialty electrodes are separated by an appropriate distance and by a membrane separator. A sludge collecting receptacle is attached to the bottom of the electrode assembly. Multiple such electrode systems in various forms and numbers are covered under this invention. The removal of the COD could be using an electrolyte could be using a flow set-up as well. An impeller is introduced in the system to create turbulences and fasten the reaction process and also introduce special processes.

In an embodiment the present invention discloses a wastewater treatment method, where the system is immersed in the wastewater tank or wastewater is added to the chamber containing the system.

In a preferred embodiment the present invention discloses a system and method for lowering the recalcitrant COD, where the levels of recalcitrant COD and contaminants can be mitigated in the wastewater from sewage, industries and hospital waste.

In another preferred embodiment, the present invention further discloses a system/composition and method to reduce the recalcitrant pollutants, including hydrocarbons, pesticides, some personal care products, non-materials, and different types of toxins, prohibit the growth of microorganisms and prevent unpleasant odors.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

It is to be noted, however, that the appended drawings illustrate only typical embodiments of the present invention and are therefore not to be considered for limiting of its scope, for the invention may admit to other equally effective embodiments. The detailed description is described with reference to the accompanying figures. In the figures, the left-most digit(s) of a reference number identifies the FIGURE in which the reference number first appears. The same numbers are used throughout the figures to reference like features and components. Some embodiments of system or methods in accordance with embodiments of the present invention are now described, by way of example, and with reference to the accompanying figures, in which:

FIG. 1 illustrates the (a) schematic representation of the system for the wastewater treatment in electrochemical flow-mode and (b) Top View of the same system showing the parallel electrodes covering the face of the chamber or hung from the lid, in accordance with an embodiment of the present invention.

The FIGURE depicts embodiments of the present invention for the purposes of illustration only. A person skilled in the art will easily recognize from the following description that alternative embodiments of the structures and methods illustrated herein may be employed without departing from the principles of the disclosure described herein.

### DETAILED DESCRIPTION

Because this is a patent document, general broad rules of construction should be applied when reading it. Everything described and shown in this document is an example of subject matter falling within the scope of the claims, appended below. Any specific structural and functional details disclosed herein are merely for purposes of describing how to make and use examples. Several different embodiments and methods not specifically disclosed herein may fall within the claim scope; as such, the claims may be embodied in many alternate forms and should not be construed as limited to only examples set forth herein.

The terms “comprises”, “comprising”, or any other variations thereof used in the disclosure, are intended to cover a non-exclusive inclusion, such that a device, apparatus, system, assembly, method that comprises a list of components or a series of steps that does not include only those components or steps but may include other components or steps not expressly listed or inherent to such apparatus, or assembly, or device. In other words, one or more elements or steps in a system or device or process proceeded by “comprises . . . a” or “comprising . . . Of” does not, without more constraints, preclude the existence of other elements or additional elements or additional steps in the system or device or process as the case may be.

Rather, exclusive modifiers like “only” or “singular” may preclude presence or addition of other subject matter in modified terms. The use of permissive terms like “may” or “can” reflect optionality such that modified terms are not necessarily present, but absence of permissive terms does not reflect compulsion. In listing items in example embodiments, conjunctions and inclusive terms like “and,” “with,” and “or” include all combinations of one or more of the listed items without exclusion. The use of “etc.” is defined as “et cetera” and indicates the inclusion of all other elements belonging to the same group of the preceding items, in any “and/or” combination(s). Modifiers “first,” “second,” “another,” etc. may be used herein to describe various items, but they do not confine modified items to any order. These terms are used only to distinguish one element from another; where there are “second” or higher ordinals, there merely must be that many number of elements, without necessarily any difference or other relationship among those elements.

When an element is related, such as by being “connected,” “coupled,” “on,” “attached,” “fixed,” etc., to another element, it can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.).

As used herein, singular forms like “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to the same previously-introduced term. Relative terms such as “almost” or “more” and terms of degree such as “approximately” or “substantially” reflect 10% variance in modified values or, where understood by the skilled artisan in the technological context, the full range of imprecision that still achieves functionality of modified terms. Precision and non-variance are expressed by contrary terms like “exactly.”

The structures and operations discussed below may occur out of the order described and/or noted in the figures. For example, two operations and/or figures shown in succession may in fact be executed concurrently or may be executed in the reverse order, depending upon the functionality/acts involved. Similarly, individual operations within example methods described below may be executed repetitively, individually or sequentially, so as to provide looping or other series of operations aside from exact operations described below. It should be presumed that any embodiment or method having features and functionality described below, in any workable combination, falls within the scope of example embodiments.

The inventor has recognized that despite the widespread use of the available tertiary treatments such as chemical oxidation, ultra-filtration, membranes, recalcitrant COD is not adequately lowered and the operational expenditures are also very high. Further, due to the commercial unavailability of media or membranes for the selective removal of the byproducts from the treatment systems, revenue loss is incurred. Besides, the physical filtration assemblies do not effectively remove gas molecules (<0.001 μm) and abatement of industrial and commercial toxic gases is mandatory. Thus, a need remains for a novel methodology in such applications which besides environmentally friendly is both economical as well as provide excellent results for reducing the recalcitrant COD, with effective removal of the byproducts. To overcome these issues, the inventor has developed example embodiments and methods described below to address these and other problems recognized by the Inventors with unique solutions enabled by example embodiments.

The present invention relates to system and method for lowering the pollutants in wastewater treatment including hydrocarbons, pesticides, nanomaterials, and different types of toxins in the wastewater from industries, sewage and electrosynthesis of reactants.

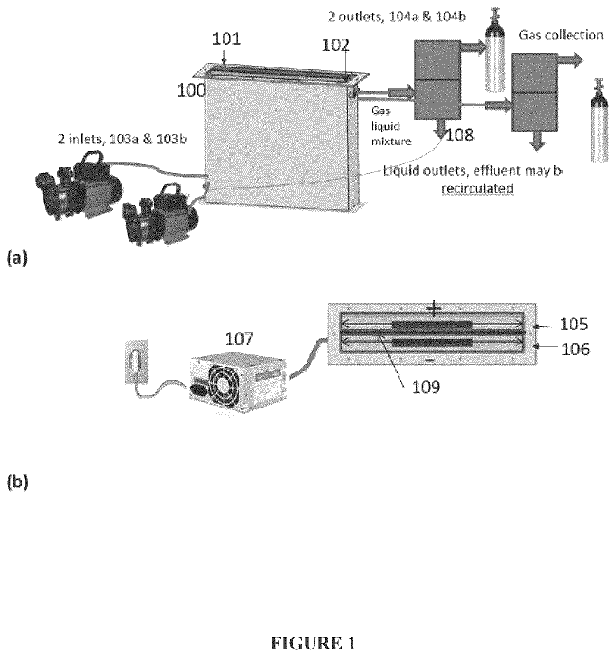

Reference may be made to FIG. 1 illustrating the (a) schematic representation of the system for the wastewater treatment in electrochemical flow-mode and (b) Top View of the same showing the parallel electrodes covering the face of chamber or hung from the lid, in accordance with an embodiment of the present invention. The system includes at least a chamber (100) containing electrodes. The system also includes at least one anode (105) and at least one cathode electrode (106) configured in the at least one anode chamber (101) and at least one cathode chamber (102) respectively. Further, the system includes at least a solar or plug in power source (107) to supply power to the electrolysis chamber. In the system, hydrogen gas is generated on the cathode which is collected by a gas absorption unit. The two specialty electrodes are separated by an appropriate distance and by an impermeable membrane (109) separator. A sludge collecting receptacle is attached to the bottom of the electrode assembly. Multiple such electrode systems in various forms and numbers are covered under this invention. The removal of COD could be using an electrolyte could be using a flow set-up as well. An impeller is introduced in the system to create turbulences and fasten the reaction process. Type of electrode is a specific feature of the system and the electrode is prepared by the hot and cold pressing process for electrode stability and high current. High purity graphite electrodes are employed in the process for more conductivity and faster electron transfer. Besides, for extracting the byproducts and gases the anode and cathode chambers have to be separate. If the byproducts are two gases, then mixing of two chambers might result in intermixing of the gases. In an embodiment to efficiently separate the cathodic and anodic streams of the effluents so that different reactions can go on two separate anodic and cathodic chambers are used as per the treatment required.

The chamber comprises: at least one inlet (103a), for inflow of wastewater having oxidable components, for the anode chamber (101) of the electrolysis chamber (100), at least one inlet (103b) for inflow of wastewater having reducible components for the cathode chamber (102) of the electrolysis chamber (100), at least one outlet (104a), for outlet of cleaned-up water with a first type of dissolved gases (e.g. oxygen), from the anode chamber (101) of the electrolysis chamber (100), and at least one outlet (104b), for outflow of cleaned-up water with a second type of dissolved gases (e.g. hydrogen), from the cathode chamber of the electrolysis chamber (100). The flow through design incorporates the separate inlets for the anodic and cathodic chamber at the bottom side plate and the separate outlets at the opposite ends at the top ensuring laminar flow of the respective catholyte and anolyte liquids. This does not allow too much mixing of the liquids at the same time allowing ion exchange and efficient heat dissipation from reactions at the electrodes.

The membrane is of a thin film composite type where the active layer is polyamide (PA) active layer (˜50-100 nm thickness), supported by an asymmetric polysulphone support (˜30-60 μm thickness).

The invention further relates to a system with electrodes comprising graphene, purified graphite and resins. The overall electrical conductivity of the mixture is very high. The special catalysts that are embedded in the electrodes enable the special reactions to take place. Further, the electrodes can be pressed by hot or cold process. In another embodiment inert polymer powders such as Teflon and or PVDF are added to the electrodes composition for generating corrosion resistant electrodes. In an embodiment coal tar pitch, produced from controlled distillation of coal tar is used as a binding agent in the production of the electrodes. For solid pitch, the material is melted at a temperature 80 C plus of its softening point which is around 105 C. The molten pitch is useful for the fusion and graphitization of the electrodes. In an embodiment special electrolytes and pH adjusters such as sodium bicarbonate are added to the wastewater that is being treated. This enhances and adjusts the conductivity for enabling the efficient redox reactions. Further, the present invention discloses a method for treatment of wastewater and reducing recalcitrant COD including the steps of immersing the system in the wastewater. In the system, hydrogen gas is generated on the cathode which is collected by a gas absorption unit. The two specialty electrodes are separated by an appropriate distance and by a membrane separator. A sludge collecting receptacle is attached to the bottom of the electrode assembly. Multiple such electrode systems in various forms and numbers are covered under this invention. The removal of COD could be using an electrolyte could be using a flow set-up as well. Hydrogen gas released in turn is collected in a tank and an impeller is introduced in the system to create turbulences and fasten the reaction process.

The said non-sacrificial electrodes comprise 95 to 100% graphite, <1% graphene, 0 to 1% catalyst, resin optional 0 to 30%, corrosion inhibiting polymer optional 0 to 10%.

The electrodes are separated by an appropriate distance of 1 cm to 20 cm by said membrane separator so that maximum current can be harnessed without compromising safety risk of electrodes touching and or heat generated not getting dissipated,

Generally, the challenging industrial wastewater treatment applications often do not have functional COD lowering mechanisms, such as with metal finishing, food and beverage, oil and gas produced water, fractional flowback, and mine drainage including treatment of produced water from oil and gas exploration and production and industrial wastewater from metal finishing and textile dyeing industries. Also, there is a need for finding cost-effective ways to recycle and reuse treated wastewater to lower cost of operation, such as reusing industrial wastewater for boiler feed, built-to-order, high-performance wastewater treatment systems for challenging waste such as oily wastewater or waste streams containing large amounts of suspended solids. The initial treatment step may comprise of filtration and ultrafiltration (UF) which is capable of removing emulsified organics and suspended solids down to low micron levels. The second step of the integrated process is where the current technology particularly has a role to further remove dissolved organic and inorganic compounds. Where, finally, the purified effluent is suitable for discharge or reuse.

In an embodiment the system is an openable system, where though the method doesn't involve generation of any sludge. But even if any sludge is generated during the process, then this sludge can be removed from the chamber. In an embodiment the electrodes are in the lid of the chamber and the lid can be easily removed to clean the chambers. In the closed electrolysis systems heat is generated and hydrogen released as a byproduct might lead to explosion. But, being an open system, heat is well dissipated and hydrogen gas released can be separated and stored as a byproduct and used for further processes.

In an embodiment the electrode is heated to form a porous electrode for increasing the surface area for the electro-transformation process. Difference in the composition of the electrodes makes a difference in the type of wastewater treatment and the reaction efficiency. In an embodiment pressed and conventional made electrodes can be used for the system. The electrode comprises of 1% Cu+30% resin+70% pure graphite with 1-5% graphene. Further the anode and cathode electrodes can be same or different depending upon the reaction or byproduct desired. Surface area of electrode in the electrolytic cell affects the rate of reaction. Increase in the surface area of the electrode also enhances the rate of reaction in the electrolytic cells. Also, current flowing through the electrodes also increases.

In an embodiment, the electro transformation system (oxidation & reduction) of scrubber water is saturated with corrosive gases such as CO2, SOX, NOX etc. which are generally absorbed into alkali water. This scrubber water which is an effluent can be transformed into useful products such as Formic acid+methanol (CO2); SOX (sulphide, bisulphide, and sulphate). These can be effectively utilized as valuable material in construction industry.

In an embodiment the wastewater is treated by Electro-oxidation (EO), a process also known as anodic oxidation or electrochemical oxidation, used for wastewater treatment, mainly for industrial effluents. It is a type of advanced oxidation process, where the anode and the cathode electrode are connected to a power source and specific amount of voltage is applied. When sufficient supporting electrolyte are provided to the system, strong oxidizing species are formed, which interact with the contaminants and degrade them. It does not require any external addition of chemicals (contrarily to other processes like in-situ chemical oxidation), as the required reactive species are generated at the anode surface. Cathode electrodes are mostly made up by stainless steel plates, platinum mesh or carbon felt electrodes. When voltage is applied to the electrodes, intermediates of oxygen evolution are formed near the anode, notably hydroxyl radicals. Hydroxyl radicals are known to have one of the highest redox potentials, allowing the degrading of many refractory organic compounds.

In an embodiment the Electro-oxidation may occur either by direct oxidation by hydroxyl radicals produced on anode's surface or by an indirect process where oxidants like chlorine, hypochlorous acid and hypochlorite or hydrogen peroxide/ozone are formed at electrodes by following reactions:

2Cl⁻→Cl₂+2e⁻

Cl₂+H₂O→HOCl+H⁺+Cl⁻

HOCl→H++OCl⁻

H₂O→*OH+H⁺+e⁻

2*OH→H₂O₂

H₂O₂→O₂+2H++2e−

O₂+*O→O

Oxidation occurs when species such as active chlorine species are generated from chloride ions anodically to destroy pollutants. In so-called mediated electro-oxidation, metal ions are oxidized on an anode from a stable state to a reactive high valence state, which in turn attack pollutants directly and may also produce hydroxyl free radicals to promote degradation.

In an embodiment the method is a zero-sludge process, i.e., during the process of oxidation no sludge is formed and it can work as a standalone treatment process for wastewaters that are very difficult to treat because it requires no chemical input and generates negligible sludge.

In an embodiment the wastewater is treated by Electro-reduction also known as cathodic reduction or electro chemical reduction. The redox reagent is electrogenerated by either anodic or cathodic process, where one of the schemes could be with H2O2 which is generated at the cathode with O2 or air feeding while an iron catalyst is also regenerated on the cathode surface. Other technologies such as coagulation based on dissolution of iron impregnated anodes (peroxi-coagulation (PC)), ultrasound irradiation dissolution of heterogeneous catalysts that supply Fe2+ (Heterogeneous-Electro Fenton) and bioremediation (bio-Electro Fenton) are also covered. The decontamination based on the cathodic H2O2. Electro generation can be also promoted via the oxygen reduction reactions in acidic and alkaline medium:

O₂(g)+2H⁺+2e - - - >H₂O₂

O₂(g)+H2O+2e - - - >HO2−+OH

If H₂O₂ is cathodically electrogenerated in an undivided cell without pH control, the process is called anodic oxidation (AO) with H2O2 (AO-H2O2, anode produces adsorbed OH, H₂O₂ and HO2, as well as by active chlorine when Cl is present). Meanwhile, if the AO-H₂O₂ is performed, at acidic pH (˜3.0), in presence of iron ions (added or already present in the effluent), EF technology occurs because Fenton's reaction is attained in the solution bulk producing homogeneous OH. Supported or chelated iron catalysts have been also used to extend the working pH range or cathodes that can favor the continuous Fe2+regeneration from reaction, and comparable degradation efficiencies were achieved by PC and EF, indicating that is a suitable scheme. Here the iron is specially impregnated into the graphite based dimensionally stable electrodes:

Fe2++H₂O₂ - - - >Fe3++OH−+OH−

Fe3++e− - - - >Fe2+

Fe2++2e - - - >Fe

In an exemplary embodiment the invention discloses an electrolytic system for lowering the pollutants in wastewater treatment and electrosynthesis of reactants, comprising: an electrolysis chamber with at least one anode chamber, at least one cathode chamber, at least one inlet for inflow of wastewater in the electrolysis chamber, and at least one outlet duct for outflow of byproducts of electrolysis, at least one anode and at least one cathode configured within the electrolysis chamber, where the composition of each of the at least one anode and the at least one cathode comprises non-sacrificial carbon, resin and catalyst. The entire surface of the anode and the cathode is exposed for maximum current to pass through for enabling enhanced flow of reactants and at least one membrane separating the anode and cathode chamber, to avoid intermixing of reactants in the two chambers; and one outlet for collecting reusable water. The flow is introduced in the electrolysis chamber to accelerate the rate of reaction and a recycling conduit is connected with electrolysis chamber by means of a recirculation pump for recalculating the wastewater. At least one anode and at least one cathode electrode is configured in the at least one anode chamber and at least one cathode chamber respectively for exposing the maximum surface of the electrodes for maximum current to pass. The flat electrodes may cover entire planar area of the chamber or may be hung from the lid. Further, the system includes at least a solar or plug in power source to supply power to the electrolysis chamber.

In an embodiment, the anode electrode is a carbon-based electrode comprising graphene, graphite, resin and catalyst made by hot or cold pressing and the cathode electrode comprises graphene, natural graphite flakes purified by dilute sulfuric acid process, resin, catalyst, stainless steel or sandwiched stainless steel. Further, the electrode comprises of 95 to 100% graphite, <1% graphene, and 0 to 1% catalyst, resin optional 0 to 30%, insulator optional 0 to 10%, where the electrode is optionally housed in a steel frame.

In a preferred embodiment, the electrode is Teflon impregnated to increase the mechanical strength and the anode and cathode electrode is used interchangeably depending upon the type of waste treatment or the electrosynthesis reaction. In an embodiment, at least one of the electrodes is a porous electrode and the flux of reactants is more due to the enhanced surface area of the electrodes.

In another embodiment, the catalyst is selected from a group comprising platinum group metals (PGM metals) as well as transition metals such as copper, ruthenium, palladium, platinum, silver, zinc, molybdenum, graphene, CNTs. Further, the particulate resin is selected from the group consisting of synthetic resins, pumice, and artificial pellets, Phenolic Resin, Phenol Formaldehyde Resin, Ultra-high-molecular-weight polyethylene.

In an embodiment, the membrane (109) for separating the anode and the cathode chamber is selected from an ion exchange membrane, reverse osmosis membrane and combinations thereof, with variable pore size depending upon the desired wastewater treatment and the by product to be separated.

In another embodiment, the anode chamber and cathode chamber comprise at least one inlet duct and one outlet duct for controlled oxidation and reduction reaction in the anode chamber and the cathode chamber.

In a preferred embodiment the present invention discloses a method for treating wastewater and electrosynthesis of reactants, comprising the steps of: (a) adding the wastewater or reactant solution to an electrolyzer or reactor chamber wherein said electrolyzer comprises a dimensionally stable graphene anode and a cathode in at least one anode and at least one cathode chamber; (b) electrolyzing and oxidizing/reducing the wastewater for lowering the pollutants with continuously introducing strong electrolytes to the electrolysis chamber for lowering the current and in turn accelerating the reaction rate, wherein simultaneous oxidation and reduction take place in two chambers as per the requirement; (c) introducing flow in the chambers by spargers or gas turbulence; and (d) collecting the by-products produced during the treatment process, wherein the one of the by product is at least a gas for further action. Further, the strong electrolyte for fastening the reaction in the electrolysis chamber is selected from a group comprising sodium sulphate, sodium chloride, potassium chloride, potassium hydroxide and combinations thereof and the energy source is plug in or solar energy for maintaining the voltage in the system.

In an embodiment, the process is fastened by continuously recirculating the wastewater through a recycling conduit connected with said reactor by means of a recirculation pump and the by product is bubbled back to the chamber for faster electro chemical process.

In another embodiment, a cathodic current density of about 20-500 A/m2 is applied to said reactor and the gases from the wastewater is purified gases by means of filters and separation of outlet gas and liquid is by a headspace mechanism. The Headspace analysis permits the detection of volatile substances in a liquid or solid sample and minimizes column contamination. In this a small volume of the sample is placed in a vial sealed with a septum and the sample vial is equilibrated at an appropriate elevated temperature.

In an embodiment, the electrolysis process for wastewater treatment is an electro oxidation and reduction process and uses non sacrificial carbon electrodes selected on the basis of the capacity to generate hydroxyl radicals and other secondary oxidants.

### EXAMPLE

Example 1: Experiments were conducted where the COD was monitored in both the anolyte as well as the catholyte compartments where the compartments were separated by an ionic membrane. Reactions at the anode included the oxygen evolution, diffusion, electrolyte oxidation, water oxidation and radical coupling. Reactions at the cathode included the reduction reaction where reducible substances were broken down into simpler and usable components. By this dual action a lot of the complex molecules were broken down into simpler more usable by-products. It was found that a drastic lowering of the COD took place in both the compartments. After a period of about an hour of the reaction a little of the sludge separated out which can be filtered out. The results from the specialty device to lower recalcitrant COD is mentioned in the table 1.

TABLE 1
Results

| | | Source of | Initial | Final |
|---|---|---|---|---|
| | Parameters | Water | COD | COD |
| Sample 1 | pH 11, TDS 14750 | pharma | 2160 | Nil |
| Sample 2 | pH 12, TDS 34200 | Paint pigment | 12840 | 1000 |
| Sample 3 | High levels | unknown | 91010 | 2100 |
| Sample 4 | High levels | unknown | 86,800 | 3980 |
| Sample 5 | High levels | dye chemistry | 14368 | 2240 |

Example 2: Green Hydrogen generation along with abatement of industrial water: Experiments were conducted where the Industrial effluent treated and COD was measured. The Industrial wastewater was converted into reusable water by the reduction of the recalcitrant COD which meets the discharge compliance. Further, hydrogen gas was removed as a byproduct from the anode chamber.

In the closed electrolysis systems heat is generated and hydrogen released as a byproduct might lead to explosion. But, being an open system, the heat is managed and hydrogen gas released can be separated and stored as a byproduct and used for further processes. Overall, the recalcitrant COD can be drastically lowered and the hydrogen gas evolved can be used for energy generation. The device can be used again and again and minimum maintenance is needed for most types of wastewater.

Example 3: Agrochemical Wastewater treatment: Chemical Oxygen Demand of Water before treatment was 2500 ppm. Chemical Oxygen Demand of Water after one-pass was 1200 ppm. The process had no chemicals dosing and the treated water had no chlorine smell and the treatment prevented the growth of micro-organisms.

Example 4: Removal of butylamine from factory effluent by Electrooxidation: Experiments were conducted with Factory effluent containing Butylamine and COD was calculated before and after treatment. Initial COD before treatment was 4,00,000 ppm. Catalytic oxidation resulted in breakdown of these into NH2, NH3, NH4SO4 and then was electrochemically converted into butyraldehyde by electro-oxidation where the COD dropped to 1200 ppm (recirculation). In the reduction compartment only sodium sulphate was passed through and the treatment in turn resulted in 99.7% reduction of recalcitrant COD.

Example 5: Electroreduction of Carbon Dioxide: For the industrial effluents containing carbon dioxide as the contaminant, carbon dioxide was converted into simple organic fuels and chemicals by the mechanism of electroreduction. The CO2 reduction at the cathode chamber was accompanied by water oxidation at anode or photoanode and the low-temperature CO2 conversion processes was based on electrocatalytic and photoelectrochemical approaches. The reaction provided means for both reducing emissions of CO2 into atmosphere and storing renewable energy. The CO2 released was collected in the chambers containing water. The CO2 released as a byproduct was bubbled back to the chambers containing wastewater having KOH, which in turn absorbed CO2 and resulted in the release of carbonate and bicarbonate species. Different by products could be separated based upon the membrane potential applied in the reaction. (Table 2)

TABLE 2
The probable reactions and potentials for this scheme are as listed

| Reaction | Reduction Potential (V) |
|---|---|
| CO₂ + 2 H⁺ + 2 e⁻ → HCOOH | −0.61 |
| 2 CO₂ + 12 H⁺ + 12 e⁻ → C₂H₄ + 4 H₂O | −0.349 |
| 2 CO₂ + 12 H⁺ + 12 e⁻ → C₂H₅OH + 3 | −0.329 |
| H₂O | |

Example 6: Addition of Na2SO4: Voltage is the driving force for the efficient electrochemical reaction and for an effective reaction the voltage should be low and current should be high. And to maintain that in an electrochemical system containing one anode electrode and one 99% pure graphite electrode as the cathode electrode, 1% Na2SO4 was added to the electrolyte chamber and it was observed that addition of 1% Na2SO4 resulted in surge in the current at the same voltages. This in turn enhanced the rate of reaction. Further, as the flow rate was high it prevented the inter-mixing of the liquids in the two chambers.

TABLE 3
Results

| Volt | Amp |
|---|---|
| 2.5 | 0.9 |
| 3.4 | 2.0 |
| 4.4 | 3.0 |
| 6.4 | 5.0 |
| 7.1 | 5.9 |
| 8.1 | 7.0 |
| 9.6 | 8.4 |
| 10.7 | 9.8 |
| 11.4 | 10.8 |
| 11.9 | 11.3 |
| Add 1% Na₂So₄And continue | |
| 11.7 | 18.1 |
| 11.4 | 22.2 |
| 11.4 | 24.4 |
| 11.4 | 26.5 |

Example 7: Multiple chambers in a row: In an example embodiment the system can work with multiple chambers in a row to enhance the efficiency of the chamber as per the requirement. For this wastewater was treated in an electrochemical set-up with 2% Na2SO4, two anode electrodes and two 99% graphite-based electrodes as the cathode electrodes. 22.8 Amps of current at only 8.1 volts showed that high Na2SO4 along with increasing the number of electrodes and in turn increasing the chambers resulted in faster rate of reaction and thus more abatement of the chemical oxygen demand of the wastewater.

Agrochemical sample was treated for abatement of the chemical oxygen demand in the multiple chamber system (2% Na2SO4, two anode electrodes and two 99% graphite-based electrodes as the cathode electrodes) and the results substantiated the fact that multiple chambers resulted in faster rate of reaction and thus more abatement of the chemical oxygen demand of the wastewater. By product is also different here.

Example 8: Molded and or pressed electrodes resulted in higher efficiency. In an embodiment, the electrodes are molded by a hot process or cold process. The abatement of COD is faster when the electrochemical system involves molded electrodes as compared to the conventional electrodes. In an embodiment then molded cathode electrodes provide even higher efficiency then the anode as the molded electrodes (2% Na2SO4 25 liter with two molded electrodes as the anode and two conventional electrode as the cathode electrodes) (Table 4)

TABLE 4

| Volt | Amp |
|---|---|
| 7.1 | 9.8 |
| 8.8 | 13.4 |
| 11.9 | 20.2 |
| 12.2 | 20.6 |

In an embodiment sparger or flow is introduced in the system for enhancing the efficiency of the system for abatement of COD. Of the three modes of transport in the system: conduction, convection and diffusion; the convection/flow plays a major role in modulating the efficiency of the water treatment process. It was observed that increasing the flow rate in the chamber resulted in better efficiency. (Solution: 2% Na2So4, with two molded anode electrodes and two conventional electrodes as cathode). In an embodiment, the possibility of fast flow-rates prevents mixing of streams and increase in current (Table 5), which in turn accelerates the rate of reaction. Besides, separate chambers for oxidation and reduction, there is flexibility of multiple electrodes in series each covering the entire planar area of the chamber.

TABLE 5
current in the system with and without the flow:

| | |
|---|---|
| Without flow | With flow |

| Volt | Amp | Volt | Amp |
|---|---|---|---|
| 2.7 | 2.2 | 1.7 | 0.7 |
| 4.4 | 4.7 | 3.0 | 2.2 |
| 5.2 | 6.1 | 3.7 | 3.5 |
| 6.6 | 8.4 | 4.7 | 5.2 |
| 7.4 | 9.8 | 5.4 | 6.7 |
| 8.1 | 11.1 | 6.1 | 8.0 |
| 9.1 | 12.9 | 7.4 | 10.3 |
| 9.8 | 14.1 | 8.3 | 12.1 |
| 10.4 | 15.6 | 11.9 | 18.5 |
| 11.2 | 16.7 | 11.9 | 19.1 |
| 11.9 | 17.0 | 11.9 | 19.8 |
| | | 11.9 | 20.0 |

Overall, the recalcitrant COD can be drastically lowered and the hydrogen gas evolved can be used for energy generation. The device can be repeatedly used with minimum maintenance for most types of wastewater. Further its easy to clean and maintain the system if any sludging at all occurs. Further, for the wastewater treatment, the system is immersed in the wastewater tank or wastewater is added to the chamber containing the system and a solar energy based current source can be used for the system. This would truly be the case of energy generation and waste treatment using renewable sources.

### Potential Application:

1. For disinfection of public and private pools, where radicals are generated through electro-oxidation with electrodes in order to destroy the microorganisms in the water. Compared to other disinfection methods, these systems do not require chemicals dosing, they do not produce any chlorine smell and may prevent algae formation.
2. Ammonia removal during waste-water treatment using electro-oxidation.
3. Electrochemical oxidation at the anodes can be applied to degrade different organic pollutants and disinfect drinking water and municipal wastewaters.
4. For the treatment of highly refractory dyes.
5. For degrading methyl orange azo dye in a recirculation flow plant system.
6. The innovative approach of combining membrane filtration techniques such as nano filtration (NF) and microfiltration (MF) with electrooxidation (EO) treatment as described.
7. EO treatment together with biological oxidation can be used in individual, combined and integrated methods.
8. For removal of 2,4-dichlorophenol from synthetic wastewater and removal of sulphides from domestic wastewater.
9. A complete COD reduction for azo dye in sulfate medium at pH 3.0 and photodecomposition of intermediates such as generated Fe(III)-carboxylate complexes via the reactions.
10. Removal of COD from chlorinated herbicides and removal of COD and color from textile wastewater using metal impregnated anode and graphite at cathode.
11. Removal of harmful gases, methylparaben and TOC from industrial effluent.
12. Removal of dissolved organic carbon from dyes mixture and from winery wastewater.
13. The simultaneous generation of electricity and the treatment of wastewater by means of reverse electrodialysis with salinity gradients coupled to EF as well as a wind-powered EO process for removing herbicides by using BDD electrodes, respectively.

In accordance with advantages of the present invention as compared with the existing formulations, the present invention is to provide a big change in the field of wastewater treatment, with a cost efficient and reusable energy efficient process of lowering the COD for wastewater treatment. Challenging industrial wastewater treatment applications often do not have functional COD lowering mechanisms, such as with metal finishing, food and beverage, oil and gas produced water, fractional flowback, and mine drainage including treatment of produced water from oil and gas exploration and production and industrial wastewater from metal finishing and textile dyeing industries. Also, there is a need for finding cost-effective ways to recycle and reuse treated wastewater to lower cost of operation, such as reusing industrial wastewater for boiler feed, built-to-order, high-performance wastewater treatment systems for challenging waste such as oily wastewater or waste streams containing large amounts of suspended solids. The initial treatment step may comprise of filtration and ultrafiltration (UF) which is capable of removing emulsified organics and suspended solids down to low micron levels. The second step of the integrated process is where the current technology particularly has a role to further remove dissolved organic and inorganic compounds. Where, finally, the purified effluent is suitable for discharge or reuse.

It will be further appreciated that functions or structures of a plurality of components or steps may be combined into a single component or step, or the functions or structures of one-step or component may be split among plural steps or components. The present invention contemplates all of these combinations. Unless stated otherwise, dimensions and geometries of the various structures depicted herein are not intended to be restrictive of the invention, and other dimensions or geometries are possible. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention. The present invention also encompasses intermediate and end products resulting from the practice of the methods herein. The use of “comprising” or “including” also contemplates embodiments that “consist essentially of” or “consist of” the recited feature.

Although embodiments for the present invention have been described in language specific to structural features, it is to be understood that the present invention is not necessarily limited to the specific features described. Rather, the specific features and methods are disclosed as embodiments for the present invention. Numerous modifications and adaptations of the system/component of the present invention will be apparent to those skilled in the art, and thus it is intended by the appended claims to cover all such modifications and adaptations which fall within the scope of the present invention.

1. An electrolytic system for abating pollutants in wastewater treatment and electrosynthesis of reactants, comprising:
an electrolysis chamber having at least one anode chamber with a first reactant and at least one cathode chamber with a second reactant;
an inlet for the anode chamber configured to permit inflow of wastewater having oxidable components;
an inlet for the cathode chamber configured to permit inflow of wastewater having reducible components;
an outlet from the anode chamber configured to permit outflow of cleaned-up water with a first type of dissolved gases;
an outlet from the cathode chamber configured to permit outflow of cleaned-up water with a second type of dissolved gases, wherein the electrolysis chamber is configured to permit laminar flow of the first and the second reactants from one of the inlets to a respective one of the outlets;
an anode and a cathode within the electrolysis chamber, wherein the anode and the cathode are non-sacrificial electrodes including carbon, resin, and catalyst, and wherein an entire surface of the anode and an entire surface of the cathode are exposed so as to come into direct contact with and pass current through any fluid flowing around the anode and cathode; and
a semi-permeable membrane separating the anode chamber and the cathode chamber and configured to allow passage of water molecules but preventing passage of at least a portion of dissolved salts, organic materials, and bacteria.

2. The system of claim 1, further comprising:
an energy source; and
a recirculation pump configured to circulate wastewater into the electrolysis chamber from a recycling conduit.

3. The system for treating wastewater and electrosynthesis of reactants as claimed in claim 1, wherein the anode is a carbon-based electrode comprising graphene, graphite, resin and catalyst made by hot or cold pressing.

4. The system for treating wastewater and electrosynthesis of reactants as claimed in claim 3, wherein the catalyst is at least one of platinum group metals, copper, ruthenium, silver, zinc, molybdenum, graphene, and CNTs.

5. The system for treating wastewater and electrosynthesis of reactants as claimed in claim 3, wherein the particulate resin is at least one of synthetic resins, pumice, and artificial pellets, phenolic resin, phenol formaldehyde resin, ultra-high-molecular-weight polyethylene, and coal tar pitch.

6. The system for treating wastewater and electrosynthesis of reactants as claimed in claim 1, wherein the cathode includes graphene, natural graphite flakes purified by dilute sulfuric acid process, resin, catalyst, stainless steel, or sandwiched stainless steel.

7. The system for treating wastewater and electrosynthesis of reactants as claimed in claim 1, wherein the electrode is Teflon impregnated to increase the mechanical strength and the anode and the cathode is used interchangeably depending upon the type of waste treatment or the electrosynthesis reaction.

8. The system for treating wastewater and electrosynthesis of reactants as claimed in claim 1, wherein at least one of the anode and the cathode is porous.

9. The system for treating wastewater and electrosynthesis of reactants as claimed in claim 1, wherein the inlets and the outlets enable controlled oxidation and reduction reaction in the anode chamber and the cathode chamber.

10. The system for treating wastewater as claimed in claim 1, wherein the membrane for separating the anode and the cathode chamber is at least one of an ion exchange membrane, and reverse osmosis membrane, and wherein the membrane has variable pore size of less than 1 micron.

11. The system for treating wastewater as claimed in claim 1, wherein the membrane is a thin film composite type having an active layer of polyamide and approximately 50-100 nm thickness, supported by an asymmetric polysulphone support of approximate 30-60 μm thickness.

12. The system for treating wastewater as claimed in claim 1, wherein the non-sacrificial electrodes are at least 95% graphite and less than 1% graphene.

13. The system for treating wastewater as claimed in claim 1, wherein the electrodes are separated by an appropriate distance of 1 cm to 20 cm by the membrane.

14. A method for treating wastewater and electrosynthesis of reactants, the method comprising:
adding the water to be treated to an electrolyzer chamber wherein the electrolyzer includes a dimensionally stable graphene anode and a cathode in an anode chamber and a cathode chamber;
electrolyzing and oxidizing/reducing the wastewater for lowering pollutants therein by continuously introducing strong electrolytes to the electrolysis chamber for lowering the current, wherein simultaneous oxidation and reduction take place in the anode chamber and the cathode chamber as per the requirement of the by-products in the process;
introducing flow in the chambers;
collecting by-products, wherein the by products include gas; and
circulating the gas back to the electrolysis chamber for a faster electro chemical process.

15. The method for treating wastewater as claimed in claim 14, wherein the process is made faster by continuously re-circulating the wastewater through a recycling conduit connected with the reactor by a recirculation pump.

16. The method for treating wastewater as claimed in claim 14, wherein the strong electrolyte for lowering the current and in turn accelerating the rate of reaction in the electrolysis chamber is selected from a group including at least one of sodium sulphate, sodium chloride, potassium chloride, and potassium hydroxide.

17. The method for treating wastewater as claimed in claim 14, wherein the electrolyzing include applying a cathodic current density of about 20-500 A/m2 to the electrolyzer.

18. The method for treating wastewater as claimed in claim 14, further comprising:
filtering the gasses with at least one of filters and separation of outlet gas and liquid by a headspace separator.

19. The method for treating wastewater as claimed in claim 14, wherein the anode and the cathode are non-sacrificial carbon electrodes configured to generate hydroxyl radicals and other secondary oxidants.
